(19) United States
(12) Patent Application Publication
(10) Pub. No.: US 2008/0056187 A1
(43) Pub. Date: Mar. 6, 2008

(54) System For Grouping Users To Share Time-Frequency Resources In A Wireless Communication System

(75) Inventors: Anthony C.K. Soong, Plano, TX (US); Yunsong Yang, San Diego, CA (US); Jianmin Lu, San Diego, CA (US)

Correspondence Address: AKIN GUMP STRAUSS HAUER & FELD, LLP, P O BOX 688, DALLAS, TX, 75313-0688, US

(73) Assignee: FUTUREWEI TECHNOLOGIES, INC., Plano, TX (US)

(21) Appl. No.: 11/780,435

(22) Filed: Jul. 19, 2007

Related U.S. Application Data
(60) Provisional application No. 60/824,283, filed on Aug. 31, 2006.

(51) Int. Cl. H04Q 7/00

(52) U.S. Cl. 370/330

(57) ABSTRACT

A system of methods and constructs that enable multiple users to simultaneously share transmission (i.e., radio) resources, while reducing delay for users with delay-sensitive applications, is disclosed. The system provides for: forming one or more than one shared persistent (or “sticky”) assignment (SSA) group in a sector; allocating more than one shared sticky resource in at least one SSA group; and dividing users into at least a first class of users and a second class of users. The first class of users is given a higher priority to access the shared resources than the second class of users when the shared resources become available for a new packet. The first class of users is also given more choices of shared resources when starting transmission of a new packet.

### PRIORITY CLAIM

This application claims the priority benefit of U.S. Provisional Application Ser. No. 60/824,283, filed on Aug. 31, 2006, entitled “METHOD AND APPARATUS FOR SHARING RADIO RESOURCES IN WIRELESS COMMUNICATION SYSTEM”, by Yunsong Yang, Anthony C. K. Soong and Jianmin Lu

### REFERENCE TO RELATED APPLICATION FOR PATENT

This application related to co-pending U.S. patent application Ser. No. 11/734,498, entitled METHOD AND APPARATUS FOR SHARING RADIO RESOURCES IN AN OFDMA-BASED COMMUNICATION SYSTEM, filed Apr. 12, 2007; which is assigned to the assignee hereof, and expressly incorporated by reference herein.

### TECHNICAL FIELD OF THE INVENTION

The present invention relates generally to wireless communication systems and, more particularly, to a system for sharing of radio resources among a plurality of mobile stations while reducing latency for users with time-sensitive applications.

### BACKGROUND OF THE INVENTION

In a wireless communication system, radio resources that are used to carry voice or data traffic are shared by a plurality of mobile stations—also known as users—in a particular cell, by utilizing one or more different types of multiplexing techniques. These multiplexing techniques may include: Frequency Division Multiplex Access (FDMA), where radio resources are divided into frequency blocks over a time interval; Time Division Multiplex Access (TDMA) where radio resources are divided into time intervals for users; Code Division Multiplex Access (CDMA) where radio resources are divided using orthogonal or pseudo-orthogonal codes over a time interval; Orthogonal Frequency Division Multiplex Access (OFDMA) where radio resources are divided using orthogonal frequency sub-carriers over a time interval; or some combination of the aforementioned techniques.

Radio resources may be allocated by a base station to a particular user (e.g., on a mobile station) for transmission of a single packet or a relatively short, limited time interval. This type of resource assignment is known as non-persistent, or non-sticky, assignment. Radio resources may also be allocated by a base station to a particular user for transmission of multiple packets, until a de-assignment action is triggered. This type of resource assignment is known as persistent, or sticky, assignment. Multiple actions may trigger a de-assignment of a sticky resource, including: techniques such as explicit de-assignment messages; expiration of pre-set timers; repeated loss of packets; and other system or device events. Significant savings in overhead is possible using sticky assignments rather than limited duration, or single packet assignments.

However, when utilizing sticky assignments, there always exists a possibility of unused or underutilized radio resources. This underutilization condition can occur in a variety of circumstances. One example is when a sticky assignment is to a Voice over Internet Protocol (VoIP) user; and a VoIP packet terminates early or ⅛ rate voice frames are blanked off. When this occurs, sticky radio resources assigned to this user are left unused as the user waits for the arrival of a next VoIP packet.

In the aforementioned and incorporated U.S. patent application Ser. No. 11/734,498, a method referred as Shared sticky assignment (SSA) is disclosed, enabling time-sharing of radio resources that have been assigned to at least one user, by sticky assignment, and at least another user, with sticky or non-sticky assignment. In this technique, each user is assigned a unique identifier, such as a MAC Identifier, or MACID. The unique identifier is associated with a scrambling code unique to that particular user. When using scrambling codes, more than one user may share a particular radio resource. However, only one user may be served by a base station using the shared radio resource at any given time. A transmitter at the base station scrambles a data sub-packet with the scrambling code of the user for which the sub-packet is intended.

In this shared sticky assignment method, each user that may be a recipient for the packet attempts to unscramble the received data sub-packet with a scrambling code assigned to that particular user. If a received sub-packet is intended for a particular user, the unscrambling operation performed at the receiver successfully reverses the scrambling process performed at the transmitter, and the receiver may therefore decode the sub-packet correctly. In contrast, if a received sub-packet is not for a particular user, the unscrambling operation performed at the receiver does not reverse the scrambling process performed at the transmitter, and the packet cannot be decoded correctly.

With hybrid automatic repeat request (H-ARQ), more than one transmission of a data packet, in the form of sub-packet, may be needed before sufficient energy and coded symbols are accumulated for the packet to be decoded correctly. Consequently, a receiver adds received symbols of the sub-packet to a detection buffer, even if the packet is not decoded correctly, so that these received symbols can be soft-combined with symbols obtained from transmission of a next sub-packet. Corruption of the detection buffer (i.e., a severe impairment to detection performance) can happen if symbols intended for a user are mixed with symbols intended for another user. To avoid such corruption, the start of a new H-ARQ packet may be signaled to all users. If a user receives notification that a new H-ARQ packet has started, that user may flush the detection buffer. The beginning of a new H-ARQ packet may be indicated by a signal, known as an ARQ Instance Sequence Number (AI_SN), which toggles between two states when transmission for a new H-ARQ packet starts, and remains at its previous state when transmission is for a previously failed sub-packet. This AI_SN indicator may be within the header section of a sub-packet, or it can be on a separate signaling channel. Other means for indicating the start of a new H-ARQ packet are also possible.

An issue with this scheme arises when, as illustrated with reference to diagram 100 in FIG. 1, a VoIP user 130—who is assigned to a particular resource 110 with a sticky assignment—shares resource 110 with a best effort (BE) data user 140—who is assigned to resource 110 with either a sticky or non-sticky assignment—and the BE user 140 consumes resource 110 with its pending H-ARQ re-transmission. VoIP user 130 must wait until the pending H-ARQ re-transmission of BE user 140 is successfully completed, or maximum re-transmission limit has been reached, before VoIP user 130 can use channel resources 110. This can result in excessive delays for time-sensitive applications, such as VoIP, and result in degradation of quality of service (QoS).

In the illustration of FIG. 1, multiple users may share one channel resource by performing blind decoding on the channel resource, and by monitoring the AI_SN indicator to flush each detection buffer when a new H-ARQ packet starts. In the example illustrated above, users 130 and 140 share channel resource 110 and monitor AI_SN indicator 120, as the arrows indicate. An SSA group is formed by users assigned to a specific shared channel resource. Multiple independent SSA groups are permitted in a particular sector.

As a result, there is a need for methods and/or constructs that provide the ability for multiple users to share radio resources, reducing delays for users with time-sensitive applications; and further need for a system that provides preferential treatment to users with time-sensitive applications over users without time-sensitive applications.

### SUMMARY OF THE INVENTION

The present invention provides a system, comprising various methods and apparatus, that enhances overall system efficiency by providing the ability for multiple users to share a same radio resource—thereby reducing delay for users with time-sensitive applications. The system of the present invention provides shorter queuing delay, and better QoS, for users with time-sensitive applications; by giving those users with time-sensitive application preferential treatment over users without time-sensitive applications. The preferential treatment may be, but is not limited to, higher priority access to shared resources, and a greater choice of shared resources for starting transmission of a new H-ARQ packet. The system of the present invention minimizes signaling overhead for configuring and assigning shared resources.

Various embodiments of the present invention provide multiple users methods and structures to share a transmission resource, while reducing latency for users with time-sensitive applications. One or more shared sticky assignment (SSA) group(s) is (are) formed in a sector. More than one shared sticky resources are allocated in at least one SSA group, and users are divided into at least a first and second classes. The first class of users is given higher priority to access shared resources than the second class, when the shared resources become available for starting transmission of a new H-ARQ packet. The first class of users is given more choices of shared resources than the second class of users when starting transmission of a new packet.

The present invention further provides methods and constructs for minimizing signaling overhead associated with: setting up an SSA group of the type described above; adding or removing a user to or from the SSA group; indicating H-ARQ status on shared resources; and indicating identity of an intended user for a current transmission.

The following description and drawings set forth in detail a number of illustrative embodiments of the invention. These embodiments are indicative of but a few of the various ways in which the present invention may be utilized.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 provides an illustrative depiction of PRIOR ART methods for sharing a radio resource among multiple users;

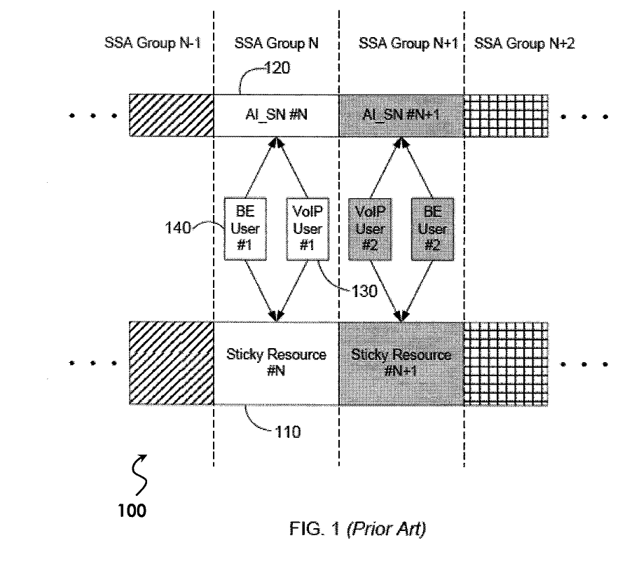

FIG. 2 depicts an illustrative example of resource sharing according to the present invention;

FIG. 3 depicts an illustrative example of another embodiment of resource sharing according to the present invention; and

FIG. 4 depicts an illustrative example of a control channel structure that carries a shared sticky assignment message, or AI_SN indicators, according to the present invention.

### DETAILED DESCRIPTION

The following discussion is presented to enable a person skilled in the art to make and use the invention. The general principles described herein may be applied to embodiments and applications other than those detailed below without departing from the spirit and scope of the present invention as defined herein. The present invention provides a unique system of methods and constructs that enable multiple users to simultaneously share transmission (i.e., radio) resources, while enhancing performance for all users, and reducing latency for users with time-sensitive applications. Specific examples of components, signals, messages, protocols, and arrangements are described below to simplify the present disclosure. Well-known elements are presented without detailed description in order to avoid obscuring the present invention with unnecessary detail. The present invention is not intended to be limited to the embodiments shown, but is to be accorded the widest scope consistent with the principles and features disclosed herein.

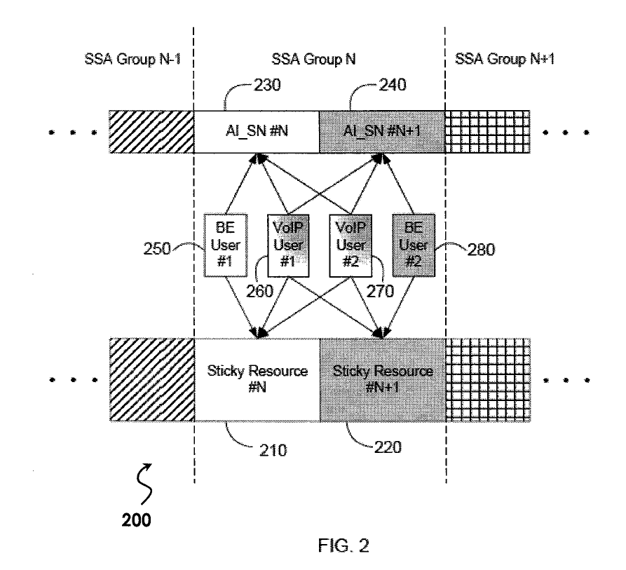

Referring now to FIG. 2, one embodiment of a resource-sharing scheme 200 according to the present invention is illustratively depicted. In FIG. 2, an SSA Group N comprises two shared sticky resources 210 and 220. In a first embodiment, each of these shared resources forms an independent channel to carry data traffic for different users. AI_SN indicators 230 and 240 indicate whether or not a new packet has started in the shared sticky resources 210 and 220, respectively. AI_SN indicators 230 or 240 may toggle between a first state and a second state when a new packet starts in each respective shared sticky resource. Otherwise, AI_SN indicator 230 or 240 may remain in its previous state. In the example depicted in FIG. 2, a BE user 250 and two VoIP users 260 and 270 share first sticky resource 210, while the same two VoIP users 260 and 270 and a second BE user 280 share second sticky resource 220.

A transmitter at an associated base station scrambles an encoded data sub-packet with a scrambling code associated with the user for which the sub-packet is intended. A receiver of a sub-packet unscrambles the received data sub-packet with the scrambling code that is assigned to that particular user. If the received sub-packet is for a particular user, the unscrambling process reverses the scrambling process performed at the transmitter, and the receiver of this user may decode the sub-packet correctly. On the other hand, if the received sub-packet is not intended for a particular user, the unscrambling process does not properly reverse the scrambling process and the receiver of this user is not able to decode the data packet correctly.

The base station transmits the sub-packets of a particular packet to a user using the same shared resource or resources until the packet is successfully decoded, or a maximum number of retransmission attempts have occurred. Therefore, transmission to a user who is assigned with multiple shared resources may switch among assigned shared resources only at a packet boundary, not between retransmissions of sub-packets for the same packet. This reduces the number of decoding hypotheses and detection buffers required when blind decoding is performed by a receiver. If complexity of a receiver is not a concern, such restrictions may be ignored.

The first BE user 250 performs blind decoding on first sticky resource 210 and monitors the associated AI_SN indicator 230, so as to flush the detection buffer in its receiver when a new packet starts on sticky resource 210, as indicated by the arrows in FIG. 2. The second BE user 280 performs blind decoding on second sticky resource 220 and monitors associated AI_SN indicator 240 so as to flush the detection buffer in its receiver when a new packet starts on sticky resource 220. The two VoIP users 260 and 270 perform blind decoding on first sticky resource 210, with the first detection buffer in each respective receiver, and monitor the associated AI_SN indicator 230 so as to flush the first detection buffer in each respective receiver when a new packet starts on sticky resource 210.

Simultaneously, the two VoIP users 260 and 270 also perform blind decoding on second sticky resource 220, with the second detection buffer in each respective receiver, and monitor the associated AI_SN indicator 240 so as to flush the second detection buffer in each respective receiver when a new packet starts on sticky resource 220. In addition, the respective BE user 250 or 280 may flush its sole detection buffer when it successfully decodes a packet, and the respective VoIP user 260 or 270 may flush both the first and second detection buffers in its receiver after successfully decoding a packet.

In FIG. 2, the BS may choose a shared sticky resource with earliest availability, from among multiple assigned shared sticky resources (e.g., resources 210 and 220), to start transmission of a new H-ARQ packet for VoIP users 260 and 270; while the BS can schedule to start transmission of a new packet for BE users 250 and 280 only on one shared resource. Although any class of users may be given a greater number of choices for available shared resources than other class of users, users with time-sensitive applications—rather than users without time-sensitive applications—may be given the greatest number of choices for available shared resources when starting transmission of a new packet.

When H-ARQ transmission of a packet on a shared resource is completed, either successfully or unsuccessfully after the maximum retransmission number is reached, the base station can give a user having a time-sensitive application a higher priority than a user not having a time-sensitive application to access vacant shared resources to start a new packet.

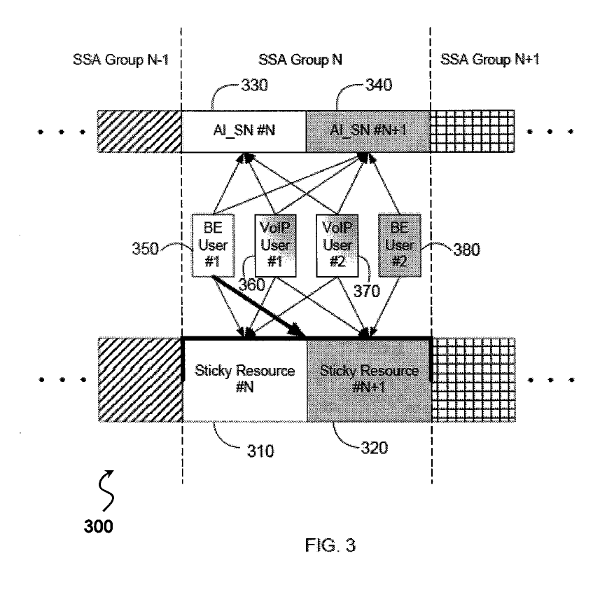

In an alternative embodiment, each of the shared sticky resources within an SSA group may form independent channels, or pipes, to carry traffic for different users. One or more shared sticky resources within a group may alternatively form a combined channel, or pipe, to carry traffic for at least one user based on: channel and traffic conditions; the user type; the availability of each shared resource; and which shared resources are assigned to the scheduled user if not all shared resources within the SSA group are assigned to the scheduled user. For example, users whose traffic may be carried by the combined pipe may be limited to the non-VoIP users, as the data rate for a VoIP application is relatively constant. In this case, those users whose traffic can be carried by the combined pipe need to perform blind decoding, in view of the possibility that both the individually assigned shared pipe and the combined assigned shared pipe may carry the traffic for this user. FIG. 3 provides an illustrative depiction of such an alternative embodiment 300.

Referring to FIG. 3, a BE user 350 is assigned shared sticky resources 310 and 320. In order to reduce the number of hypotheses and detection buffers that user 350 needs in order to perform blind decoding, restrictions such as limiting traffic to user 350 to either the individual pipe of resource 310, or the combined pipe of resources 310 and 320 (indicated by the bold arrow in FIG. 3), but not the individual pipe of resource 320, may be implemented. In the illustrated case, a receiver of user 350 uses its first detection buffer to perform blind decoding on the individual pipe of resource 310, and uses its second detection buffer to perform blind decoding on the combined pipe of resources 310 and 320. User 350 monitors both AI_SN indicators 330 and 340. However, when the complexity of a receiver is not a serious concern, the aforementioned limitation may be omitted.

Referring back to embodiment 200 of FIG. 2, users 250, 260, 270, and 280 are assigned to respective shared sticky resources with a sticky assignment. In addition, users without time-sensitive applications may be assigned to any of the shared resources, or combination of any of the shared resources, within an SSA group on a temporary basis (i.e., a non-sticky assignment); as long as those shared resources are available. Users assigned with non-sticky assignment to a shared resource do not need to perform blind decoding, or monitor the AI_SN indicator.

Therefore, sharing operation is transparent to a non-sticky user. Also, when the base station starts transmission of a new packet for a non-sticky user, assigning a non-sticky user to the shared sticky resources is also transparent to sticky users 250, 260, 270, and 280; as far as decoding is concerned. In order to decode their own packet, sticky users 250, 260, 270, and 280 each flush their respective detection buffer only when a new packet for the user starts. However, the base station scheduler needs to consider any potential delay that might affect time-sensitive users assigned to the shared sticky resource when scheduling a transmission for a non-sticky user, using the same shared sticky resource. In a lightly loaded shared sticky resource, adding a non-sticky user on that shared sticky resource can help to improve the overall utilization of that shared sticky resource.

According to another aspect of the present invention, techniques are provided for: minimizing signaling overhead in setting up an SSA group; adding or removing a user to or from an SSA group; indicating H-ARQ status on a shared resource (e.g., using AI-SN indicators); and indicating the identity of an intended user for the current transmission is disclosed. The control signaling of the Advanced Interface Evolution (AIE) of cdma2000 standards, currently under development, are used to illustrate certain principles of the present invention.

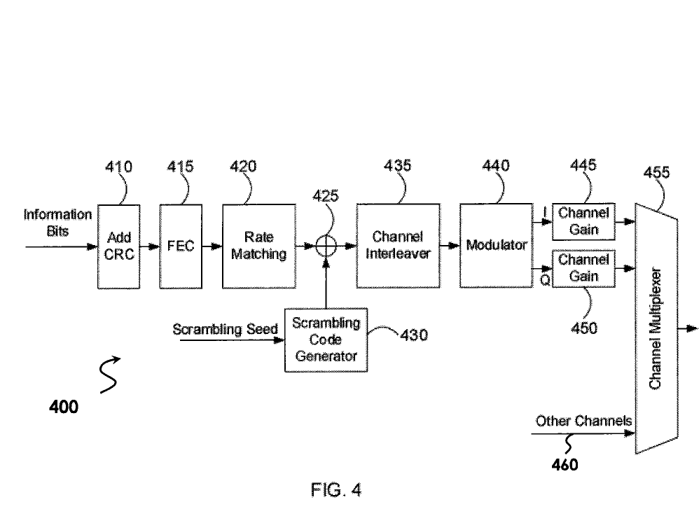

Referring now to FIG. 4, one embodiment 400 of a signal channel structure for transmitting messages for sending a shared sticky assignment, for setting up an SSA group, or for sending an AI_SN indicator, according to the present invention. Referring to FIG. 4, Cyclic Redundant Check (CRC) bits are first added to information bits of a message by CRC element 410. An encoder 415 adds forward error correction (FEC) coding to the output sequence of CRC element 410. A rate-matching element 420 repeats and/or punctures encoded bits from encoder 415 in order to match F-SSCH rate to a certain fixed rate. A scrambler 425 then scrambles the output sequence from rate matching element 420 with a scrambling code that is generated from a scrambling code generator 430. In this embodiment, scrambling code generator 430 is a PN register that is seeded with the channel identity of the control channel.

The scrambled sequence is interleaved by channel interleaver 435, and the interleaved sequence is then modulated by a modulator 440. In-phase (I) and quadrature (Q) outputs of modulator 440 are gain-controlled by channel gain elements 445 and 450, respectively. An output complex signal is then multiplexed with other channels 460 by channel multiplexer 455 using Frequency Division Multiple Access (FDMA), Code Division Multiple Access (CDMA), Time Division Multiple Access (TDMA), OFDMA, or some combination of these techniques.

For the purpose of establishing an SSA group, a layer 3 message is broadcasted to users, indicating the number of SSA groups that are being established, the number of shared resources in each SSA group, and the corresponding channel ID of each shared resource in each SSA group. This layer 3 message may explicitly indicate location of a corresponding AI_SN indicator, in a bitmap for each shared resource in each SSA group. Alternatively, location of a corresponding AI_SN indicator in a bitmap for each shared resource in each SSA group may be implicitly indicated, by the sequence of that shared resource that appears in the layer 3 message setting up the SSA groups.

For the purpose of indicating H-ARQ status on each shared resource, a bitmap of the AI_SN indicator is sent on a control channel, illustrated in FIG. 4 as information payload; where each bit corresponds to the AI_SN indicator of one shared resource, in the order that this shared resource appears in the layer 3 message establishing the SSA groups. A special scrambling code is assigned, by the same layer 3 message that establishes the SSA group for this control channel, to indicate type or purpose of the control channel; so that users can interpret the meaning of the information payload accordingly. Radio parameters such as channel ID for the control channel may be indicated by the same layer 3 message, or may be indicated by the broadcast channel in a Superframe preamble.

For the purpose of identifying an intended user of a currently transmitted sub-packet, the sub-packet is scrambled with a scrambling code that is unique to the intended user. Each user uses its unique scrambling code to descramble received sub-packets on each assigned shared sticky resource.

For the purpose of assigning a sticky user to a shared sticky resources, an assignment message is sent on the control channel, illustrated in FIG. 4, as information payload. The assignment message includes at least the identity of the intended user, a persistent (or sticky) indicator bit, Channel ID for the shared resource that the user is to be assigned, and a supplemental bit. When the user correctly receives an assignment message having the persistent (or sticky) indicator bit set, and the Channel ID belongs to one of the shared resource that has been set up in one SSA group by the layer 3 message, the user has established a shared sticky assignment. It is expected to share that resource with more users; and it will monitor the corresponding AI_SN bit in the AI_SN bitmap. In order to add additional shared resources to a user who has already been assigned at least one shared sticky resource, a supplemental bit in an assignment message is set. In order to assign a non-sticky user to a shared sticky resource on a temporary basis, the persistent bit in the assignment message is not set. In order to limit assignment to a combined pipe of multiple shared resources to a sticky user, such as user 350 in the example illustrated in FIG. 3, channel ID in the assignment message should be the parent channel ID, corresponding to the combined shared resource, and the persistent indicator bit should be set; while the supplement bit depends on whether or not the combined resource is assigned in addition to at least one different shared resource.

These constructs and methods provide finer granularity for sharing resources among multiple users by allowing multiple users, such as M users—where M is an integer greater than or equal to 1—to utilize multiple shared resources (or pipes), such as N pipes—where N is an integer greater than or equal to 1—while in previously disclosed techniques, N is always one. Therefore, the system of the present invention gradually increases sharing ratio and finds an optimum balance of system efficiency and guaranteed QoS.

The present invention also provides shorter queuing delay, thus better QoS, for the users with delay-sensitive applications, due to higher priority for shared resources and earlier availability of one shared pipe among multiple shared pipes assigned to those users. The present invention may be applied to a wireless communication system using multiplexing techniques, such as: Frequency Division Multiplex Access (FDMA), where radio resources are divided among frequency blocks over a time interval; Time Division Multiplex Access (TDMA), where radio resources are divided by time intervals; Code Division Multiplex Access (CDMA), where radio resources are divided among orthogonal or pseudo-orthogonal codes over a time interval; Orthogonal Frequency Division Multiplex Access (OFDMA), where radio resources are divided among orthogonal frequency sub-carriers over a time interval; or some combination of these techniques.

The foregoing description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for sharing radio resources among multiple users, comprising the steps of:
establishing a shared persistent assignment group;
allocating a plurality of persistent resources to the shared persistent assignment group;
assigning a plurality of users to the shared persistent assignment group;
assigning each of the plurality of users to one or more of the plurality of persistent resources;
wherein a first of the plurality of users is assigned to only one of the plurality of persistent resources; and
wherein a second of the plurality of users is assigned to two or more of the plurality of persistent resources.

2. The method of claim 1, further comprising the step of communicating a packet to one of the plurality of users utilizing the persistent resources assigned to that one of the plurality of users.

3. The method of claim 2, further comprising the step of communicating, explicitly or implicitly, an indication of starting a new packet transmission in a persistent resource.

4. The method of claim 3, further comprising the step of flushing a detection buffer of each of the plurality of users assigned to a persistent resource once each of the plurality of users detects the indication of starting a new packet transmission in the persistent resource.

5. The method of claim 3, wherein the step of communicating an indication of starting a new packet transmission comprises toggling an automatic repeat request identifier sequence number (AI_SN) indicator associated with the persistent resource.

6. The method of claim 5, further comprising the step of flushing a detection buffer of each of the plurality of users assigned to a persistent resource associated with an automatic repeat request identifier sequence number (AI_SN), once each of the plurality of users detects toggling of the automatic repeat request identifier sequence number (AI_SN) indicator associated with the persistent resource.

7. The method of claim 2, further comprising the step of scrambling the packet at a transmitter using a unique scrambling code assigned to the one of the plurality of users.

8. The method of claim 7, further comprising the step of descrambling the packet at a receiver of the one of the plurality of users using the unique scrambling code.

9. The method of claim 2, further comprising the step of prioritizing communication of a packet to a user depending on time-sensitivity of the user, wherein time-sensitive users receive priority in communication of a packet.

10. The method of claim 1, wherein a first of the plurality of users comprise users with delay-sensitive applications.

11. The method of claim 1, wherein a second of the plurality of users comprise users with delay-insensitive applications.

12. The method of claim 1, wherein the plurality of persistent resources is orthogonal, or pseudo-orthogonal, codes over a time interval using Code Division Multiplex Access.

13. The method of claim 1, wherein the plurality of persistent resources are orthogonal frequency sub-carriers over a time interval using Orthogonal Frequency Division Multiplex Access.

14. A method for providing enhanced performance for a user in a wireless communications system, the method comprising the steps of:
assigning a user to a shared sticky assignment group;
providing a plurality of sticky resources in the shared sticky assignment group;
associating the user with a subset of the plurality of sticky resources, the subset having at least two sticky resources; and
transmitting a packet to the user, using the subset of sticky resources associated with the user.

15. The method of claim 14, wherein the step of transmitting a packet to the user using the subset of sticky resources uses only a single sticky resource to transmit the packet.

16. The method of claim 15, further comprising the step of transmitting, explicitly or implicitly, an indication of starting a new packet transmission in a single sticky resource.

17. The method of claim 16, wherein the step of transmitting an indication of starting a new packet transmission further comprises the step of toggling an automatic repeat request identifier sequence number (AI_SN) indicator associated with the single sticky resource.

18. The method of claim 16, further comprising the step of flushing a detection buffer of each of the plurality of users assigned to the sticky resource associated with the automatic repeat request identifier sequence number (AI_SN), once each of the plurality of users detects indication of starting a new packet transmission.

19. The method of claim 17, further comprising the step of flushing a detection buffer of each of the plurality of users assigned to the sticky resource associated with an automatic repeat request identifier sequence number (AI_SN), once each of the plurality of users detects toggling of the automatic repeat request identifier sequence number (AI_SN) indicator.

20. The method of claim 12, further comprising the step of scrambling the packet at a transmitter using a unique scrambling code assigned to the one of the plurality of users.

21. The method of claim 20 further comprising the step of descrambling the packet at a receiver of the one of the plurality of users using the unique scrambling code, before decoding the packet.

22. The method of claim 14, wherein transmitting a packet to the user using the subset of sticky resources uses at least two sticky resources to transmit the packet.

23. A system for allocating radio resources among a plurality of users in a wireless communications network, comprising:
a base station;
a shared persistent assignment group;
a plurality of users, each assigned to the shared persistent assignment group; and
a plurality of persistent resources allocated to the shared persistent assignment group for communicating between the base station and the plurality of users.

24. The system of claim 23 wherein one or more of the plurality of users may be assigned to a combination of persistent resources allocated to the shared persistent assignment group.

25. The system of claim 23, wherein the plurality of users is divided into a first and a second class.

26. The system of claim 25, wherein the first class of users are given priority access to persistent resources over the second class of users.

27. The system of claim 25 wherein the first class of users are given preferential choice of resources for a packet transmission over the second class of users.

28. The system of claim 25, wherein the first class of users comprise users with delay-sensitive applications.

29. The system of claim 25, wherein the second class of users comprise users with delay-insensitive applications.

30. The system of claim 25, wherein the first class of users comprises users having a higher grade of service.

31. The system of claim 25, wherein the second class of users comprises users having a lower grade of service.
